(19) United States
(12) Patent Application Publication
(10) Pub. No.: US 2005/0221717 A1
(43) Pub. Date: Oct. 6, 2005

(54) Method and system for packaging scale model vehicles

(76) Inventors: Joel Quinn, South Jordan, UT (US); George E. Newby, Ririe, ID (US); Chris Sullivan, Rock Springs, WY (US)

Correspondence Address: RADER, FISHMAN & GARAUER PLLC, 10653 SOUTH RIVER FRONT PARKWAY, SUITE 150, SOUTH JORDAN, UT, 84095, US

(21) Appl. No.: 11/099,067

(22) Filed: Apr. 5, 2005

Related U.S. Application Data
(60) Provisional application No. 60/559,837, filed on Apr. 5, 2004.
(60) Provisional application No. 60/559,886, filed on Apr. 5, 2004.

(51) Int. Cl. B60B 7/06; A63H 30/00

(52) U.S. Cl. 446/454

(57) ABSTRACT

A vehicle includes a driving portion, a trailer portion removably coupled to the driving portion, and a remote control device configured to control the driving portion, wherein the trailer portion is configured to house the driving portion

### RELATED APPLICATIONS

The present application claims the benefit of U.S. Provisional Patent Application Ser. Nos. 60/559,837; and 60/559,886, both filed Apr. 5, 2004, which applications are incorporated herein by reference in their entirety.

### TECHNICAL FIELD

The present disclosure relates generally to model, remote controlled vehicles, and more particularly, to a model remote controlled semi-truck and trailer in which the box trailer is configured to receive a model truck for storage.

### BACKGROUND

Remote controlled scale model vehicles are extremely popular worldwide and are available in various different forms, such as cars, trucks, aircraft, and boats. The vehicles may be scale models of larger vehicles, such as 1/10th scale semi tractor trailers. The vehicles may be powered by nitro-methane engines and may be operated remotely by various different types of remote control devices.

Numerous components and accessories may be associated with remote controlled, model vehicles. For example, model vehicles may include remote control devices, spare parts, fuel, and tools of various different types. Organizing the model vehicles, components and accessories in a manner to facilitate storage without using excessive space, is often challenging. Also, as the amount of components and accessories increases, transporting the items becomes increasingly difficult. Furthermore, the amount of time and effort required for handling, storing, and transporting the various components and accessories is increased as the number of items increases.

### SUMMARY

In one of many possible embodiments, a vehicle includes a driving portion, a trailer portion removably coupled to the driving portion, and a remote control device configured to control the driving portion, wherein the trailer portion is configured to house the driving portion

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 is a perspective view of a model vehicle according to one exemplary embodiment.

FIG. 2 is an exploded perspective view of a model vehicle and a remote control device according to one exemplary embodiment.

FIG. 2A is a perspective view of the underside of a model vehicle trailer according to one exemplary embodiment.

FIG. 3 is a cross-sectional side view of a model vehicle in a packed condition according to one exemplary embodiment.

FIG. 4 is a side cross-sectional view of a wheel according to one exemplary embodiment.

FIG. 5 is a simple block-diagram illustrating a top view of a vehicle having a plurality of wheels according to one exemplary embodiment.

FIG. 6 is a simple block diagram illustrating a rear view of a model vehicle according to one exemplary embodiment.

FIG. 7 is a perspective view of a model vehicle and a trailer according to one exemplary embodiment.

FIG. 8 is a top view of a model vehicle being maneuvered on a roadway according to one exemplary embodiment.

FIG. 9 is a cross-sectional view of a portion of a wheel according to one exemplary embodiment.

FIG. 9A is a side view of a wheel according to one exemplary embodiment.

FIG. 9B is a side view of a wheel according to one exemplary embodiment.

FIG. 9C is a side view of a wheel according to one exemplary embodiment.

FIG. 10 is a cross-sectional view of a rim according to one exemplary embodiment.

FIG. 10A is a cross-sectional side view of a single beveled hole in a rim according to one exemplary embodiment.

FIG. 10B is a cross-sectional view of a double beveled hole in a rim according to one exemplary embodiment.

FIG. 11 is a cross-sectional view of a model vehicle packaged in a carrying bag according to one exemplary embodiment.

FIG. 11A is a cross-sectional view of a model vehicle packaged and including a handle according to one exemplary embodiment.

Throughout the drawings, identical reference numbers designate similar, but not necessarily identical, elements.

### DETAILED DESCRIPTION

The present specification discloses a system and method for storing and transporting a scale model vehicle in a spatially efficient manner. More specifically, the present specification discloses a model remote controlled semi-truck and trailer in which the box trailer is configured to receive the semi-truck and a number of associated components for storage. By incorporating the above-mentioned capabilities into a trailer of a model remote controlled semi-truck and trailer, the space occupied to contain the model remote controlled semi-truck and trailer is decreased. Alternatively, by including transport straps or a bag for carrying the packaged model remote controlled semi-truck and trailer, a user can more conveniently transport the model remote controlled semi-truck and trailer without causing harm to the model remote controlled semi-truck and trailer or any other items such as remote control devices, spare parts, fuel, and tools of various different types.

In the following description, for purposes of explanation, numerous specific details are set forth in order to provide a thorough understanding of the present system and method for packaging scale model vehicles. It will be apparent, however, to one skilled in the art, that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment

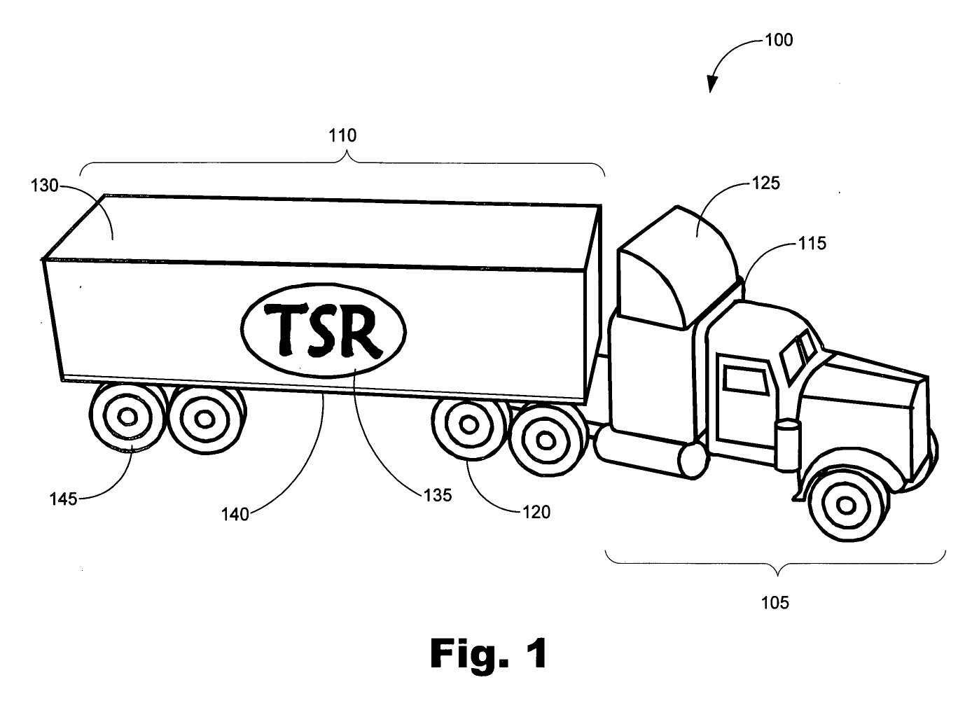

Referring now to FIG. 1, a perspective view is shown of a scale-model vehicle, indicated generally at (100). According to one exemplary embodiment, the model vehicle (100) may be a 1/10th scale model of a vehicle such as a semi-truck and trailer for example. However, models of various other sizes may be used within the scope of the present disclosure. Moreover, the model vehicle (100) may have various different configurations and appearances of different makes of vehicles. Further, the model vehicle (100) may have configurations and appearances that do not resemble full scale vehicles, within the scope of the present disclosure. Accordingly, the term “model” as used herein shall be interpreted broadly to include scale models, non-scale models, and/or other representations of vehicles.

The model vehicle may include a driving portion (105) and a trailer portion (110). The driving portion (105) may be in the form of a tractor, a truck, or any other vehicle as discussed previously. The driving portion (105) may also, according to one exemplary embodiment, include a roof spoiler (125) configured similar to roof spoilers used on full sized semi-trucks to reduce wind drag. The roof spoiler (125) may be removably attached to the cab (115) such that the height of the driving portion (105) may be reduced when the roof spoiler (125) is removed. According to one exemplary embodiment, the roof spoiler (125) may be attached to the cab (115) in a snap-fit manner, or using any variety of fasteners or attachment mechanisms.

In another exemplary embodiment, the roof spoiler (125) may be foldably attached to the cab (115), such as with a hinge, so that the roof spoiler (125) may be rotated with respect to the cab (115) to reduce the vertical dimensions of the driving portion (105) without completely removing the roof spoiler from the cab. In yet another embodiment, the driving portion (105) may be formed without a roof spoiler (125).

Turning now to the trailer portion (110), an enclosure (130) may be formed of a plurality of walls defining an interior space in a manner similar to full sized box trailers used in the transportation industry. Indicia (135), including various markings, letters, numbers, or designs, for example, may be placed on the model vehicle (100).

The trailer portion (110) may also include a bed (140) and trailer wheels (145). The bed (140) may be removably attachable to the enclosure (130) such that the trailer portion (110) may be used as a flat bed trailer without the enclosure (130), or the trailer portion (110) may be used with the enclosure (130) attached to the bed (140).

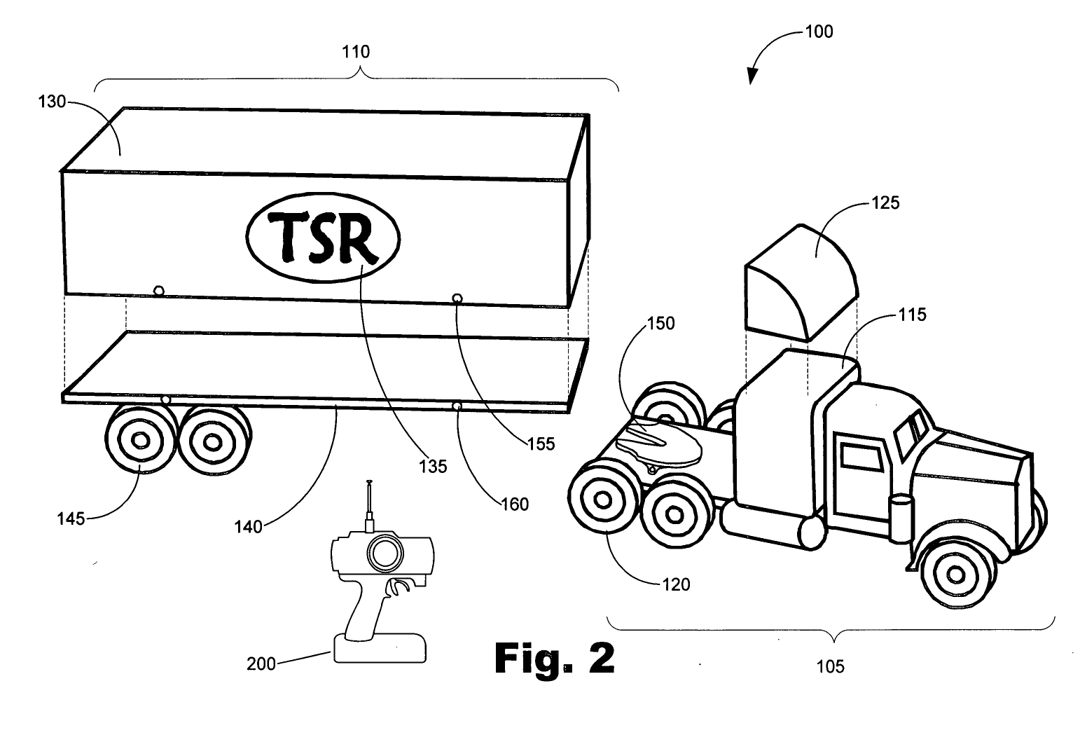

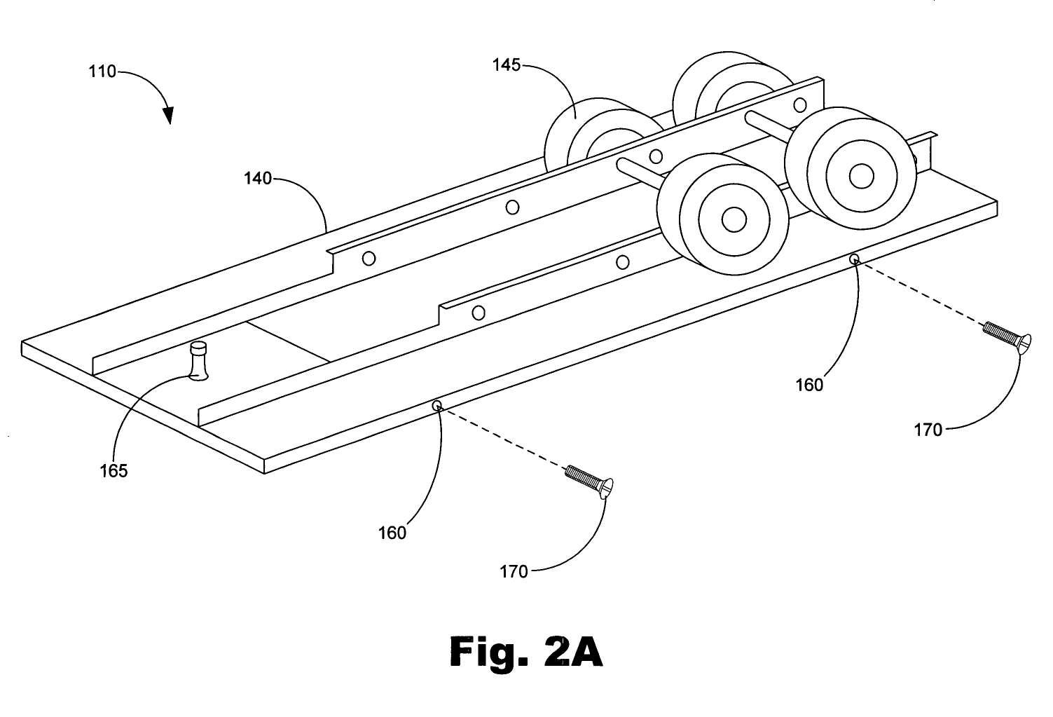

In one embodiment, the enclosure (130) may have enclosure apertures (155) that align with bed apertures (160) in the bed (140) for receiving fasteners (170), as shown in FIG. 2A, for attaching the enclosure (130) to the bed (140). The fasteners (170) may be formed as pins, rods, or screws, for example, or any other attaching mechanism that is used to removably affixing one element to another. Any number of bed apertures (160) may be formed within the bed (140) and the bed apertures (160) may be positioned in locations as desired in the bed (140). Similarly, the enclosure apertures (155) may be provided in any variety of numbers and locations corresponding to the bed apertures (160) in the bed (140).

In one exemplary embodiment, the enclosure (130) has eight enclosure apertures (155) with two enclosure apertures (155) being placed on each of the four sides of the enclosure (130). According to this exemplary embodiment, the bed (140) includes eight corresponding bed apertures (160) with two bed apertures (160) being placed on each of the four sides of the bed (140). Both the enclosure apertures (155) and the bed apertures (160) may be threaded to receive threaded fasteners (170) such as screws, according to one exemplary embodiment.

Turning now to FIG. 2, which shows an exploded view of the model vehicle (100), the driving portion (105) may include a cab (115) and a hitch (150), such as a fifth wheel hitch, for attaching to the trailer portion (110). A variety of connecting mechanisms may be used to connect the driving portion (105) to the trailer portion (110). Accordingly, the driving portion (105) may be used for towing the trailer portion (110), when coupled via the hitch (150).

According to one exemplary embodiment, the driving portion (105) further includes any number of engines or electric motors used for powering a vehicle including, but in no way limited to, an engine powered by nitro-methane, or an electrical motor, for example. The driving portion (105) also includes a plurality of wheels (120) similar to full sized semi-trucks. The driving portion (105) is controlled by a remote control device (200; FIG. 2) such that the model vehicle (100) is operated from a location spaced a distance apart from the model vehicle (100) as is common when operating remote controlled model vehicles.

The remote control device (200; FIG. 2) may have any variety of control mechanisms such as wheels, knobs, switches or buttons, for example, to enable a user to control movement of the model vehicle (100), including the speed, acceleration, and steering of the model vehicle (100).

FIG. 2A is a perspective view of an underside of the bed (140). A fifth wheel pin (165) may be provided on the bed (140) for attaching to the hitch (150; FIG. 2) on the driving portion (105; FIG. 1). Accordingly, as the driving portion (105; FIG. 1) drives the trailer portion (110; FIG. 2), the trailer portion (110; FIG. 2) may be allowed to articulate as do full sized semi-trucks and trailers. Additionally, the enclosure (130) may be sized such that the bed (140) may fit inside the interior space defined by the enclosure (130; FIG. 2), as will be described in further detail below with reference to FIG. 3.

FIG. 3 illustrates an exemplary method for storing a scale-model vehicle, according to one exemplary embodiment. As Shown in FIG. 3, the bed (140) may be removed from the enclosure (130) and inverted such that the trailer wheels (145) may be placed within the enclosure (130). Also, other objects, such as the driving portion (105; FIG. 1), the remote control device (200; FIG. 2), fuel (300), as well as tools, spare parts, accessories or other items (305) may be placed within the enclosure (130). It will be understood that any variety of objects may be arranged within the enclosure (130) in addition to, or in place of those discussed above. Accordingly, the model vehicle (100; FIG. 1) and other objects, components, and accessories may be arranged in an organized and compact configuration for storage or transporting as a unit. This may be particularly beneficial for people, such as truckers, who have limited space.

To further enable storage in the enclosure (130), the roof spoiler (125) may be removed as discussed above, such that the driving portion (105) fits within the enclosure (130), and the roof spoiler (125) may be placed within the enclosure (130). The bed (140) may be attached to the enclosure (130) with the trailer wheels (145) inside the enclosure (130), and the fasteners (170) may be inserted through the enclosure apertures (155) and the bed apertures (160) to affix the bed (140) to the enclosure (130) much like a lid. Other mechanisms may also be used to hold the bed (140) to the enclosure, such as straps or buckles, for example.

In one exemplary embodiment, the bed (140) may not need to be attached to the enclosure (130). Some embodiments may include a lip on the bed (140) to prevent the bed (140) from completely entering the enclosure (130), or the bed (140) may be sized such that the bed (140) may not fit within the enclosure (130), but may abut with the enclosure (130) to form a lid. When the bed (140) is attached to the enclosure (130), a first surface (310) of the bed (140) may be positioned on an exterior to form a smooth flat container without substantial protrusions.

According to one exemplary embodiment, the compact storage of a scale-model vehicle in the enclosure (130) may be limited by the width of the driving portion (105). More specifically, the wheel track of the driving portion is often wider than the available width of the enclosure (130). Consequently, the present exemplary embodiment provides a method for varying the width of the driving portion (105) wheelbase to facilitate storage o the driving portion in the enclosure (130).

Rims are commonly removably attached to vehicles and have an interior side and an exterior side. Traditionally, the rims are configured only to fit on the vehicle in a single orientation. For example, the interior side of the rim may be configured to face the vehicle when the rim is attached to either side of the vehicle. Accordingly, the width of the vehicle between the wheels has traditionally been constant when the wheels are attached.

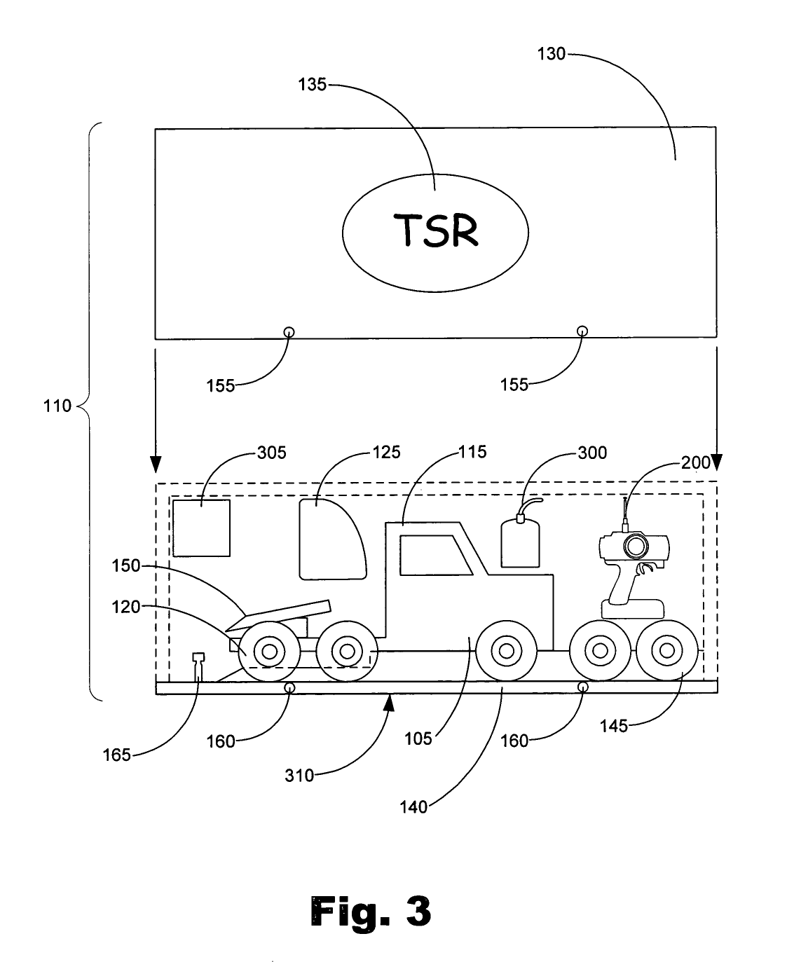

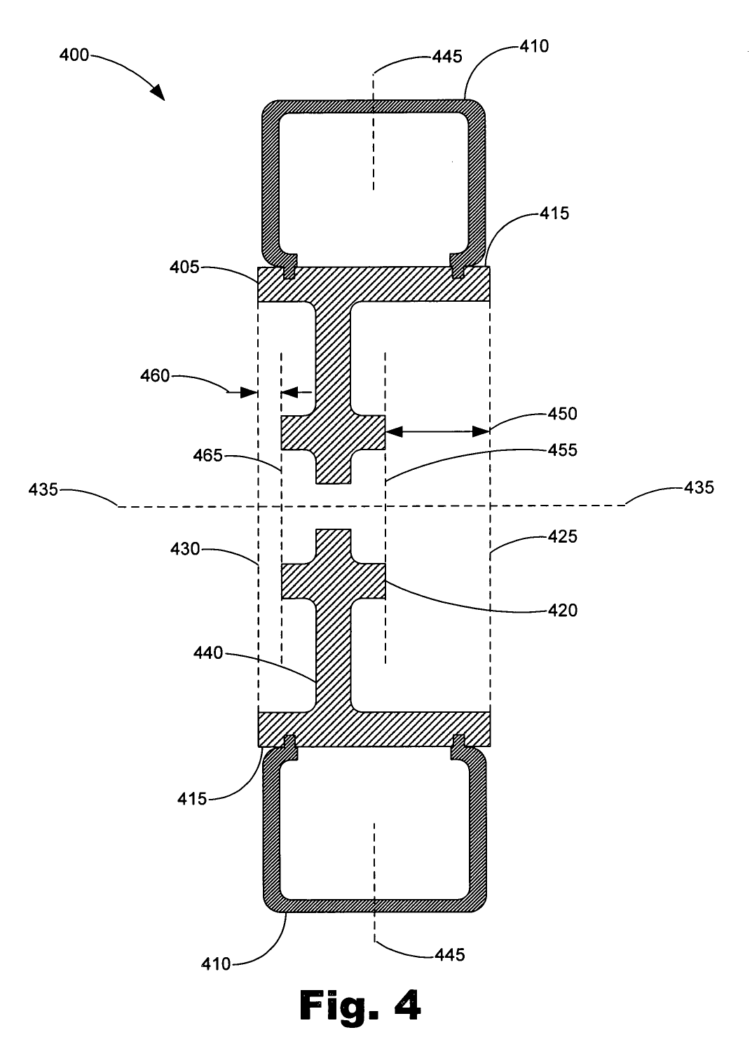

FIG. 4 illustrates a cross-sectional view of a wheel, indicated generally at (400). The wheel (400) may include a rim (405) and a tire (410). In one embodiment, the tire (410) may be formed of inflatable or non-inflatable rubber material, and may or may not include an inner tube or foam insert. In another embodiment, the tire (410) may be made of solid rubber or other material that does not need to be inflated. In yet another embodiment, the tire (410) may be removably attached to the rim (405), or the tire (410) may be fixedly attached to the rim. In still another embodiment, the tire (410) may be formed of various other materials including, but not exhaustive of, rubber, plastic, or foam. Still yet another embodiment may include wheels (400) without a tire (410).

The rim (405) may include a perimeter wall (415) defining an exterior boundary for receiving the tire (410). The perimeter wall (415) may have various different configurations and may include any of a variety of attachment means for attaching a tire to the perimeter wall (415). The rim (405) may also include a mount (420) for mounting the rim (405) on an axle hub of a vehicle. The rim (405) may include a first side (425) and a second side (430). The mount (420) may be aligned with an axis (435) that may be configured to be coaxial with an axle hub of a vehicle. The mount (420) may be supported by a wall (440) extending between the mount (420) and the perimeter wall (415). In one embodiment of the present disclosure, an upright axis (445) may extend through a center of a width of the rim (405), and the wall (440) may be configured to be offset from the upright axis (445).

The rim (405) may have a first offset (450) defined by a distance between the first side (425) of the rim (405) and a first face (455) of the mount (420). Similarly, the rim (405) may have a second offset (460) defined by a distance between the second side (430) of the rim (405) and a second face (465) of the mount (420). It will be understood that the first offset (450) and the second offset (460) may be different such that the wheel (400) may extend away from a vehicle at different distances depending on which side of the rim (405) is abutted to the vehicle. It will be understood that the first face (455) of the mount (420) and the second face (465) of the mount (420) may be machined the same to allow attachment of the rim (405) to the vehicle against both faces.

The wall (440) may be located at any suitable position between the first side (425) and the second side (430) of the rim (405). Moreover, the mount (420) may be positioned at any suitable location on the wall (440) and the wall (440) need not be centered on the mount (420). In one embodiment of the rim (405), the mount (420) may be centrally positioned on the wall (440) and the wall (440) may be positioned such that a center of the wall (440) may be located within a range of between approximately 60 to approximately 90 percent of a width of the rim (405) from the first side (425). Another embodiment may include the wall (440) positioned approximately 75 percent of the width of the rim (405) from the first side (425).

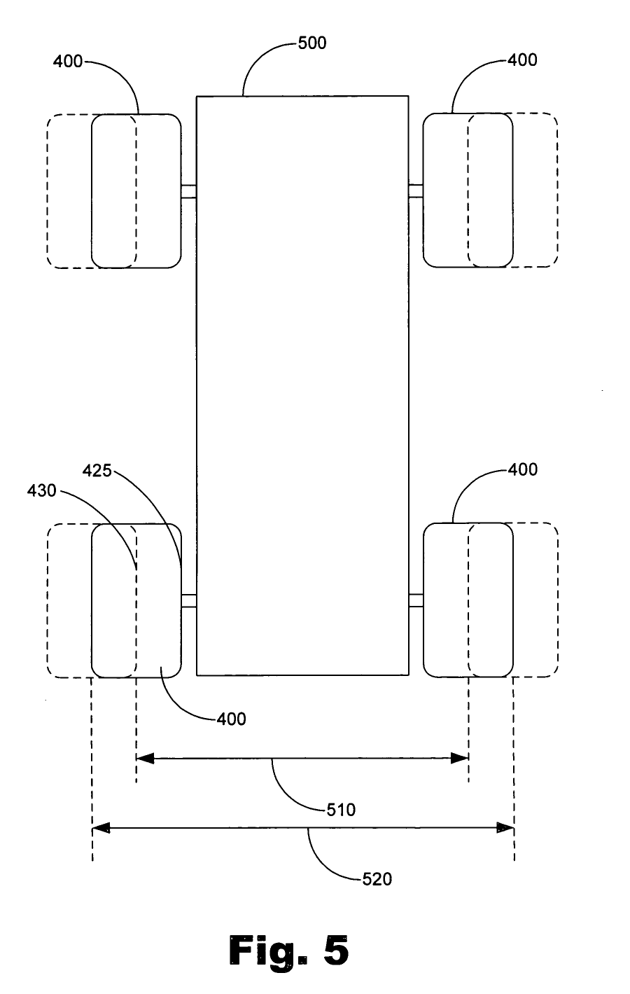

FIG. 5 shows a top view of a vehicle (500) having a plurality of wheels (400), when the wheels (400) are attached to the vehicle (500) with the first side (425) of the rim (405) facing the vehicle (500), the wheels (400) may be positioned so as to form a first wheel track (510). Moreover, the wheels (400) may be reversed, as shown in dashed lines, such that the second side (430) of the rims (405) face the vehicle (500) and form a second wheel base (520). The second wheel track (520) may be wider than the first wheel base (510). It will be understood that the first wheel track (510) and the second wheel track (520) are indicated for illustrative purposes to extend to a mid point of the wheels (400). However, it will be appreciated that the first wheel track (510) and the second wheel track (520) could be measured from different points to demonstrate the difference in track widths possible by reversing the rims (405). While the present disclosure describes the reversible wheels (400) in the context of a scale-model vehicle, it will be understood by one of ordinary skill in the art that the teachings of a reversible wheel that modifies the track of a vehicle may be extended to any size of vehicle.

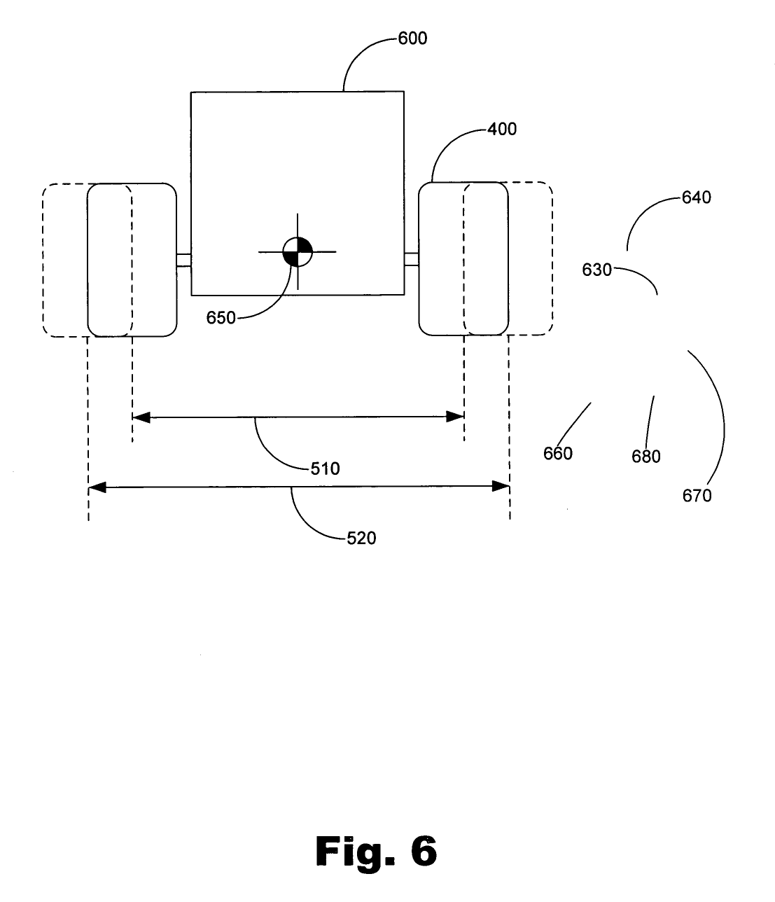

According to one exemplary embodiment, the varying the width of the wheels (400) may have a number of effects on the vehicle. As illustrated in FIG. 6, when the wheels (400) are positioned to form the first wheel track (510) a first roll angle (630) may be formed between a horizontal line (640) extending through a center of gravity (650) of the vehicle (600) and a first line (660) extending from the center of gravity (650) to a bottom center of the wheel (400), where the wheel (400) contacts a drive surface. Similarly, when the wheels (400) are positioned to form the second wheel track (520), a second roll angle (670) may be formed as defined by the horizontal line (640) extending through the center of gravity (650) of the vehicle (600) and a second line (680) extending from the center of gravity (650) to a bottom center of the wheel (400). It will be understood that the first roll angle (630) may be greater than the second roll angle (670), such that the second roll angle (670) may allow the vehicle (600) to be more stable against rolling, since the greater the roll angle, the easier it is for the vehicle (600) to roll. Consequently, traditional vehicles such as the driving portion (105; FIG. 1) of the scale model vehicle (100; FIG. 1) typically retain their wheel (400) positions according to the second wheel track (520) to maintain stability. However, as mentioned previously, the wider, more stable wheel track position may interfere with storing the driving portion (105; FIG. 1) in the enclosure (130; FIG. 1).

As illustrated in FIG. 7, the rims (405) may be oriented such that the wheels (400) and vehicle (700) form the narrower first wheel base (510), allowing the vehicle (700) to more easily fit within the trailer (110). It will be understood that the principles of the present disclosure may be utilized to allow the vehicle (700) to be more easily accommodated in various other situations, such as within containers, parking structures, or lots, for example.

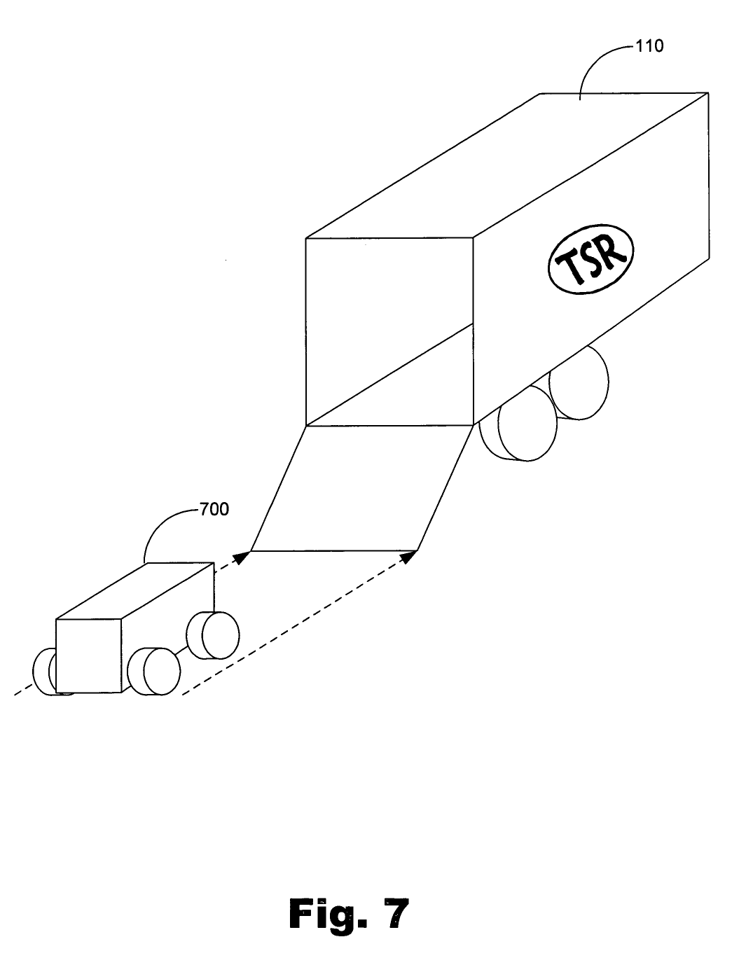

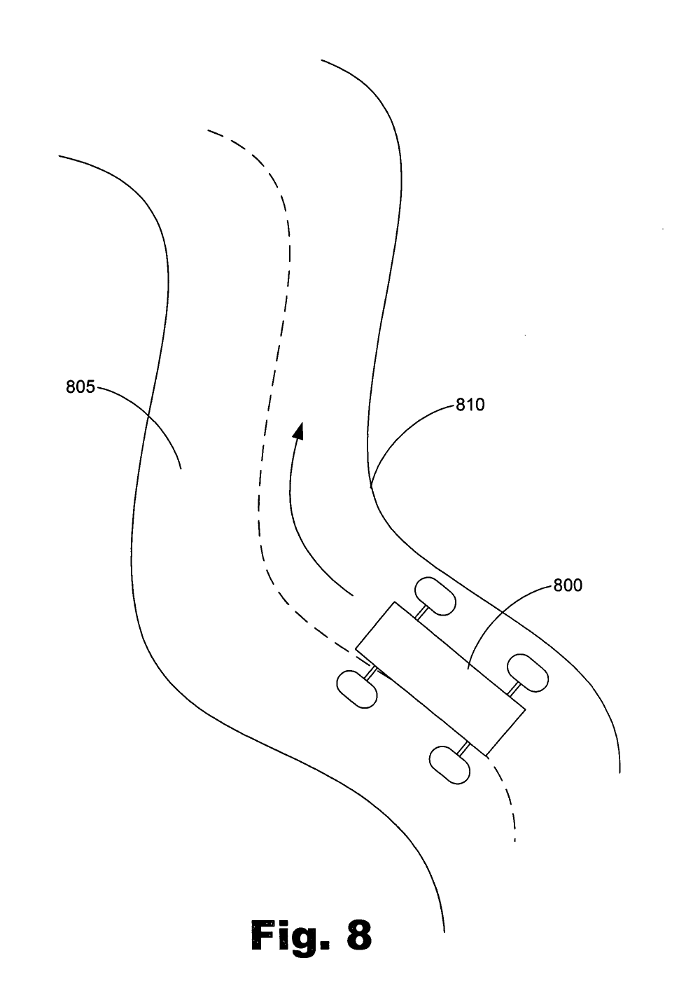

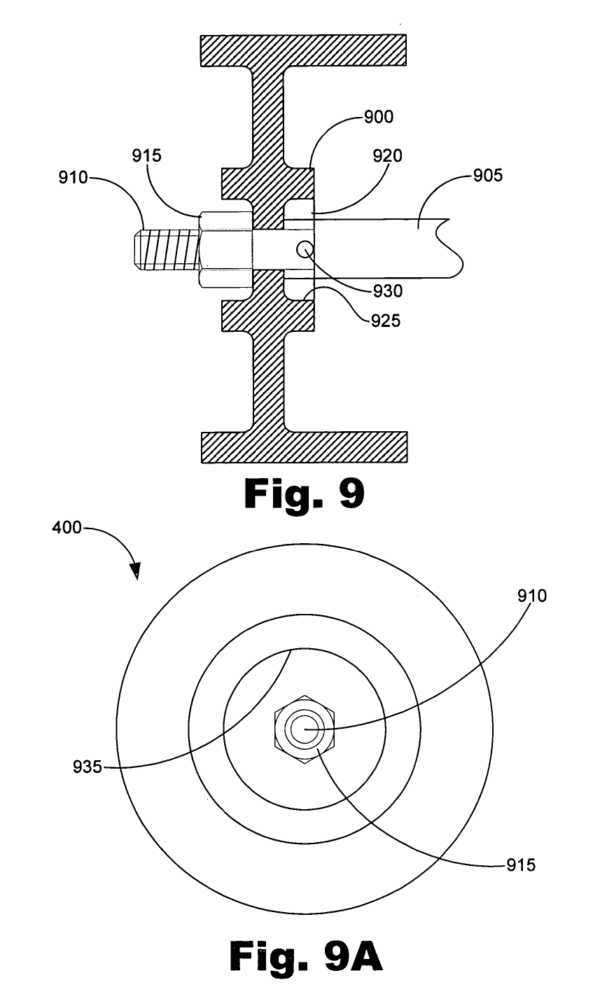

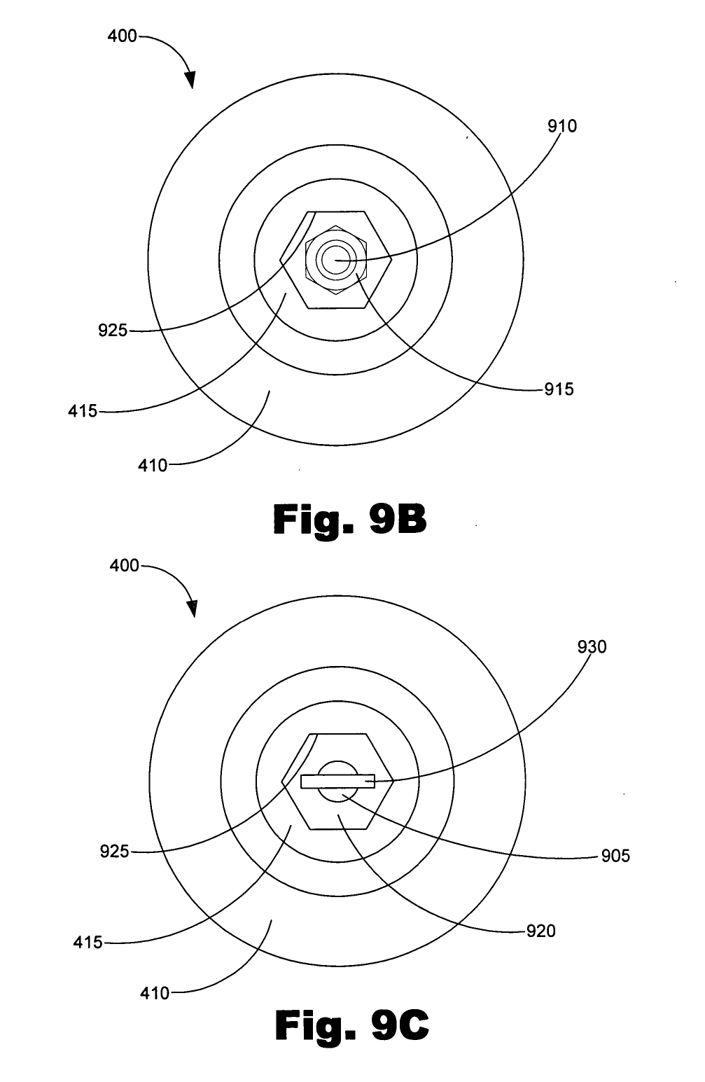

Accordingly, when a reduced vehicle width is desired, the wheels may be installed with the first side (425) of the rims (405) facing the vehicle (700). This may allow the vehicle (700) to fit in the trailer (110) to be transported to a desired location, such as a track (805) for racing the vehicle (800), as best shown in the top view of FIG. 8. Once a desired location has been reached or the vehicle (700) has been removed from the trailer (110), the rims (405) may be reversed such that the second side (430) of the rims (405) face the vehicle (800), providing a wider, more stable configuration for operation around sharp turns (810), and the like. Attachment of the rim (405; FIG. 4) to the vehicle (500; FIG. 5) will now be described in detail with reference to FIGS. 9-9C.

FIG. 9 shows a break-away cross sectional view of a mount (900) attached to a drive axle (905) of a vehicle (500; FIG. 5). As illustrated, the drive axle (905) may include a threaded end (910) for removably fastening a lock nut (915). A drive (920) may fit within a recess (925) formed in the mount (900). The drive (920) may have various different configurations compatible with the recess (925), such as polygonal shaped configurations including hexagonal shapes as shown in FIGS. 9B and 9C, or any other shape known to those skilled in the art. A pin (930) may be received in the drive axle (905) and the drive (920) to transfer rotational motion from the drive axle (905) to the drive (920).

As shown in the end view of FIG. 9A, a non-reversible design may include an annular recess (935) for receiving the threaded end (910) of the drive axle (905) and the lock nut (915). However, the annular recess (935) may not be configured to receive the drive (920) in a manner to allow the transfer of rotational forces.

As shown in FIG. 9B and 9C, the rim (405; FIG. 4) may include the recess (925) on both the first side (425; FIG. 4) of the rim and the second side (430) of the rim such that the drive (920) may be used to transfer rotational forces to the rim on either the first or the second side of the rim.

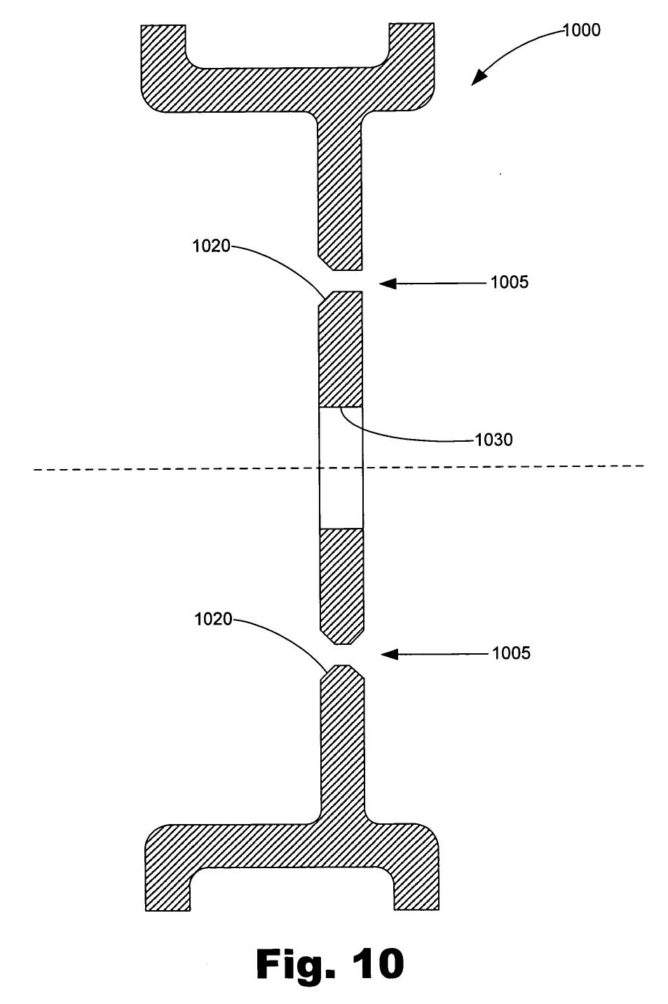

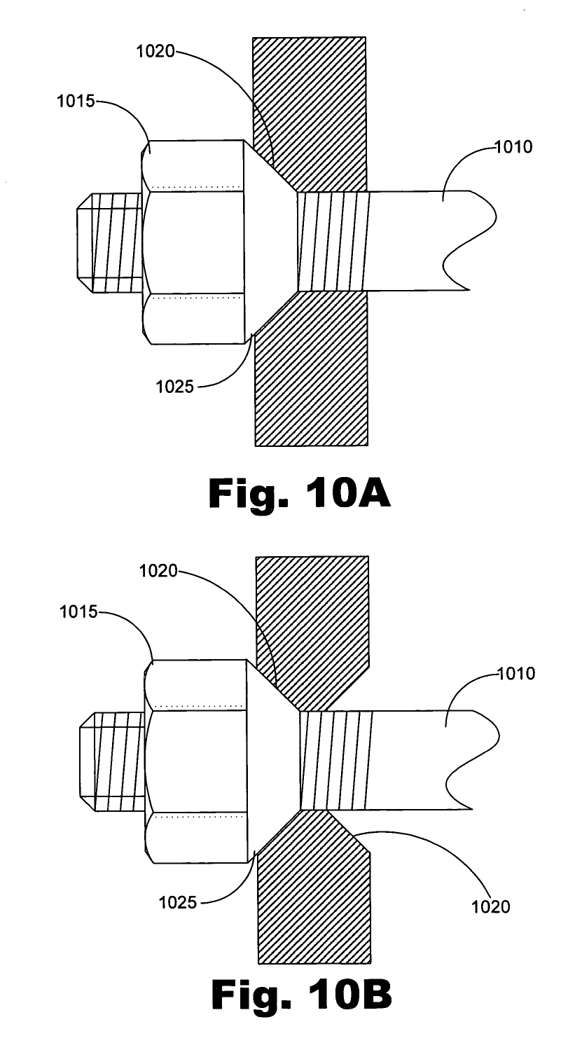

Referring now to FIGS. 10-10B, side cross-sectional views are shown of a rim (1000), according to an alternative embodiment. The exemplary rim (1000) illustrated in FIG. 10 may include many of the features of the rim (405) previously discussed. Only the differing features will be discussed herein to most succinctly describe the features present in the alternative embodiment rim (1000).

The alternative exemplary rim (1000) may include rim apertures (1005) configured to receive bolts (1010) and lug nuts (1015) to attach the rim (1000) to the vehicle. The rim apertures (1005) may include beveled portions (1020) or countersunk portions for receiving a tapered portion (1025) of the lug nut (1015). It will be understood that one embodiment of the rim apertures (1005), as best shown in FIG. 10B, may include beveled portions (1020) on both sides of the-rim apertures (1005) such that the tapered portion (1025) of the lug nuts (1015) may be received in the beveled portions (1020) regardless of the side of the rim (1000) that is directly abutted to the vehicle. However, it will be appreciated that the rim apertures (1005) may be formed with a beveled portion (1020) on only one side, as shown in FIG. 10A. Moreover, it will be understood that the rim apertures (1005) may be formed without beveled portions (1020) within the scope of the present disclosure. Additionally, the rim (1000) may include a center opening (1030) for receiving a vehicle axle hub, in a manner known to those skilled in the relevant art.

The rim (1000) may be formed of any suitable material known to those skilled in the relevant art, including but not limited to aluminum, steel, plastic, and wood. The rim (1000) may be cast, forged, injection molded, machined from a solid piece, or formed in any other manner known to those skilled in the art. Moreover, the rim (1000) may be constructed in any diameter and width to meet the requirements of a particular vehicle.

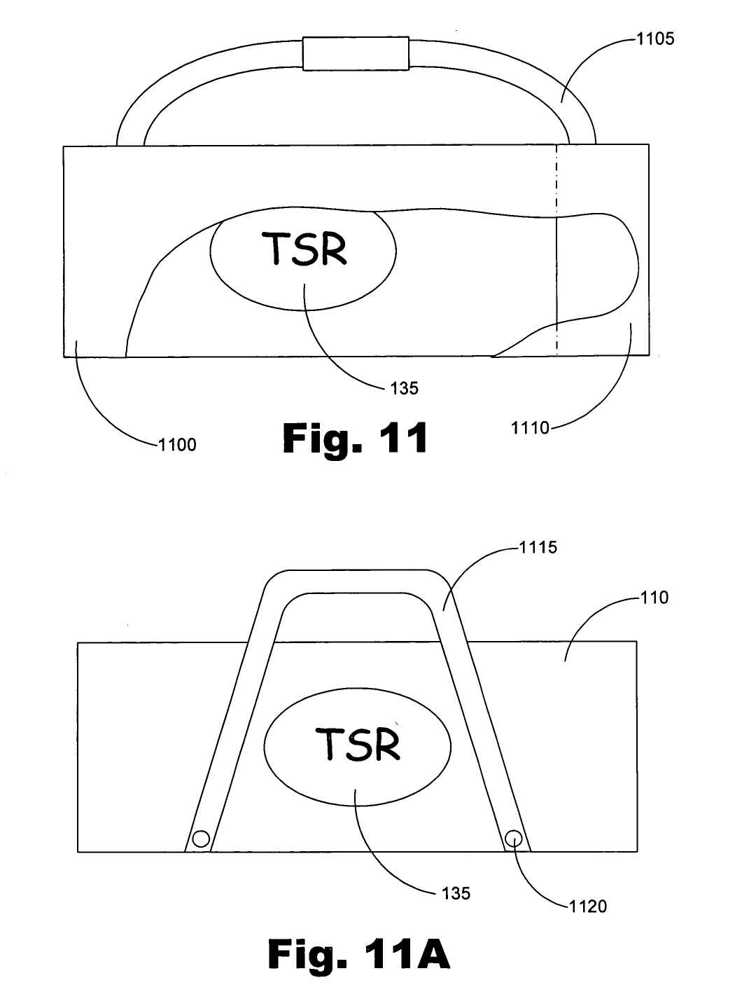

By incorporating the above-mentioned reversible rim (405), the driving portion (105; FIG. 1) of the model vehicle (100; FIG. 1) may be stored in the enclosure (130; FIG. 1). The resulting container may then be stored or transported in, for example, a bag. FIG. 11 illustrates a break-away side view of a container or bag (1100) containing the above-mentioned model vehicle (100; FIG. 1). According to one exemplary embodiment, the bag (1100) may include a bag handle (1105) to facilitate carrying the model vehicle (100; FIG. 1) in a manner known in the art. It will be understood that the bag (1100) may be formed of a soft, flexible material, such as the materials commonly associated with athletic bags. Alternatively, the bag (1100) may be made of a more rigid material, such as, but not limited to, plastic, leather, rubber, metal, wood or other synthetic or non-synthetic cloth. Also, the bag (1100) may have one or more additional pouches or compartments (1110) for receiving tools or other components or accessories.

Referring now to FIG. 11A, a side view of an alternative embodiment mechanism for carrying the model vehicle (100; FIG. 1) is disclosed. As shown in FIG. 11A, a handle (1115) may be removably attached to the model vehicle (100; FIG. 1). The handle (1115) may include handle apertures (1120) configured to align with the enclosure apertures (155; FIG. 2) in the trailer portion (110; FIG. 2) such that the fasteners (170; FIG. 2A) may be used to removably attach the handle (1115). The handle (1115) may be formed of a flexible strap material, a rigid material, or any other suitable material known to those skilled in the art. Moreover, the handle (1115) may be attached to the trailer portion (110; FIG. 2) using other connecting devices such as clasps or buckles, and the handle (1115) may be positioned on the trailer portion (110; FIG. 2) in various different configurations and arrangements. For example, the handle (1115) may be configured to extend around the long dimension of the trailer portion (110; FIG. 2), or the handle (1115) may have multiple bands that extend around both the long and short dimension of the trailer portion (110; FIG. 2).

It will be understood that the model vehicle (100; FIG. 1) may be manufactured using various different materials and methods known to those skilled in the relevant art. Similarly, the bag (1100), handle (1115), and other accessories and components discussed herein may be formed using suitable materials and manufacturing methods known to those skilled in the relevant art.

In conclusion, the present system and method provide for efficient, space-saving storage of a scale model vehicle. Additionally, the present exemplary systems and methods provide a method for reducing the width of a vehicle wheelbase for storage, while allowing for quick modification to a wider, more stable wheel base when desired.

The preceding description has been presented only to illustrate and describe embodiments of the invention. It is not intended to be exhaustive or to limit the invention to any precise form disclosed. Many modifications and variations are possible in light of the above teaching. It is intended that the scope of the system and method be defined by the following claims.

1. A scale-model vehicle, comprising:
a driving portion;
a trailer portion removably coupled to said driving portion; and
a remote control device configured to control said driving portion;
wherein said trailer portion is configured to house said driving portion.

2. The scale-model vehicle of claim 1, wherein said vehicle comprises a remote controlled scale model vehicle.

3. The scale model vehicle of claim 1, wherein said driving portion comprises one of a nitro-methane engine or an electric motor configured to propel said driving portion.

4. The scale model vehicle of claim 1, wherein said trailer portion comprises:
a bed including a generally planar surface having a first face and a second face, and at least one axel rotatably coupled to said first face; and
an enclosure removably coupled to said bed;
wherein said enclosure defines a cavity configured to house said driving portion when removably coupled to said bed.

5. The scale model vehicle of claim 4, wherein said trailer portion further comprises:
at least one enclosure aperture formed in said bed; and
at least one bed aperture formed in said bed, said bed aperture corresponding to said at least one enclosure aperture;
wherein said at least one enclosure aperture and said at least one bed aperture are configured to form a fastener lumen when said enclosure is mated to said bed.

6. The scale model vehicle of claim 4, wherein said bed is further configured to be inverted and coupled to said enclosure such that said at least one axel rotatably coupled to said first face is housed in said enclosure.

7. The scale model vehicle of claim 6, wherein said first face of said bed is configured to support said driving portion within said enclosure.

8. The vehicle of claim 1, wherein said driving portion is removably connected to said trailer portion via a hitch and a fifth wheel pin.

9. The vehicle of claim 1, wherein said driving portion further comprises a roof spoiler, said roof spoiler being removably coupled to said driving portion.

10. The vehicle of claim 1, wherein said trailer portion is further configured to simultaneously house said driving portion, a remote control configured to control said driving portion, and a fuel canister.

11. The vehicle of claim 1, wherein said driving portion further comprises:
a plurality of axels; and
a plurality of reversible wheels coupled to each of said plurality of axels;
each of said plurality of reversible wheels having a first offset and a second offset.

12. The vehicle of claim 11, wherein:
said first offset is configured to generate a narrow wheel stance for packaging said driving portion in said trailer portion; and
said second offset is configured to generate a wide wheel stance for increasing a stability of said driving portion.

13. The vehicle of claim 11, further comprising a plurality of reversible wheels disposed on an axel of said trailer portion.

14. A remote controlled scale-model vehicle, comprising:
a driving portion including one of a nitro-methane engine or an electric motor configured to propel said driving portion, a plurality of axels, and a plurality of reversible wheels coupled to each of said plurality of axels, each of said plurality of reversible wheels having a first offset and a second offset;
a trailer portion removably coupled to said driving portion, said trailer portion including a bed having a generally planar surface defining a first face and a second face, at least one axel rotatably coupled to said first face, and an enclosure removably coupled to said bed, said bed being configured to be inverted and coupled to said enclosure such that said at least one axel rotatably coupled to said first face is housed in said enclosure;
wherein said enclosure defines a cavity configured to house said driving portion when removably coupled to said bed; and
a remote control device configured to control said driving portion;
wherein said trailer portion is configured to house said driving portion.

15. The scale model vehicle of claim 14, wherein said trailer portion further comprises:
at least one enclosure aperture formed in said bed; and
at least one bed aperture formed in said bed, said bed aperture corresponding to said at least one enclosure aperture;
wherein said at least one enclosure aperture and said at least one bed aperture are configured to form a fastener lumen when said enclosure is mated to said bed.

16. The scale model vehicle of claim 14, wherein said first face of said bed is configured to support said driving portion within said enclosure.

17. The vehicle of claim 14, wherein said trailer portion is further configured to simultaneously house said driving portion, a remote control configured to control said driving portion, and a fuel canister.

18. A method for packaging and transporting a remote controlled vehicle having a drive portion and a trailer portion, comprising:
placing said drive portion of said remote controlled vehicle into said trailer portion of said remote controlled vehicle.

19. The method of claim 18, further comprising:
placing said drive portion onto a bed of said trailer portion;
securing an enclosure member of said trailer portion to said bed;
said enclosure member covering said drive portion.

20. The method of claim 19, further comprising placing said trailer portion into a receptacle for transporting said remote controlled vehicle.

21. The method of claim 19, further comprising coupling at least one handle to said trailer portion.

22. A system for varying a wheel track of a vehicle, comprising:
a reversible rim including a first side and a second side;
wherein said first side includes a first offset; and
wherein said second side includes a second offset different from said first offset.

23. The vehicle of claim 22, wherein said first offset is approximately 60 to 90 percent off center from an upright axis of said rim.

24. The vehicle of claim 22, wherein:
abutting said first side to said axle creates a first wheel track;
abutting said second side to said axle creates a second wheel track
said first wheel track being configured to package said vehicle in a narrow amount of space; and
said second wheel track being configured to increase stability of said vehicle.
